(19) United States
(12) Patent Application Publication
(10) Pub. No.: US 2026/0094948 A1
(43) Pub. Date: Apr. 2, 2026

(54) FLAGGED ELECTRODES FOR TABLESS ENERGY STORAGE DEVICES, ELECTRICAL CONNECTIONS, AND PROCESSES THEREOF

(71) Applicant: Tesla, Inc., Austin, TX (US)

(72) Inventors: Shubham Patil, Milpitas, CA (US); Pei Hsuan Lu, San Jose, CA (US); Fang Huang, Saratoga, CA (US); Frederick Atadana, Fremont, CA (US); Wayne Michael Therrien, San Jose, CA (US)

(21) Appl. No.: 18/902,466

(22) Filed: Sep. 30, 2024

(51) Int. Cl. H01M 50/533; H01M 10/0587

(52) U.S. Cl. CPC H01M 50/533; H01M 10/0587

(57) ABSTRACT

Generally described, one or more aspects of the present disclosure relate to methods, systems, and devices related to forming an energy storage device with a wound sequentially flagged electrode including an electrode film disposed over a foil, wherein the foil includes a plurality of flags, a central core surrounded by the electrode film, where each of the plurality of flags are folded toward the central core, and where the plurality of flags sequentially decrease in height proximal to the central core, joining the flags together, joining a lid to the flags, and loading the electrode into a can for final processing to form the energy storage device.

### BACKGROUND

### Field

The present disclosure relates to energy storage devices and methods of making thereof. More specifically, the present disclosure relates to tabless energy storage devices.

### Description of the Related Art

Many types of energy storage devices are currently used, including a jelly-roll design in which the cathode, anode, and separators are rolled together. In order to make electrical contact with the electrodes and the exterior of the energy storage device housing, electrode tabs electrically connect the electrodes to exterior terminals of the housing. However, ohmic resistance is increased with any increased distance current must travel along the electrode to the tab and out of the cell. Furthermore, because the tabs are additional components, they add additional thickness to the device and must themselves be rolled into the wound electrode or “jellyroll”, they increase costs and present manufacturing challenges.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In some aspects, a sequentially flagged electrode is described. The sequentially flagged electrode includes an electrode film; and a foil disposed under the electrode film, wherein the foil comprises a core edge, a can edge, and a plurality of flags positioned along a top edge, wherein the top edge is between the core and can edges; wherein the plurality of flags comprise a first flag comprising a first flag height and a second flag comprising a second flag height; wherein the first flag is positioned between the core edge and the second flag, and the second flag is positioned between the first flag and the can edge; and wherein the first flag height is less than the second flag height.

In some embodiments, the top edge further comprises a nubless region between the core edge and the plurality of flags. In some embodiments, the top edge includes a buried region between the can edge and the plurality of flags. In some embodiments, the plurality of flags sequentially decrease in height from the can edge to the core edge. In some embodiments, the sequentially flagged electrode is a wound sequentially flagged electrode, the plurality of flags are positioned at a top end of the wound sequentially flagged electrode, the core edge is positioned at a central core of the wound sequentially flagged electrode, and the can edge is positioned at an exterior side of the wound sequentially flagged electrode.

In some aspects, an electrode assembly is described, including a sequentially flagged electrode, a second electrode, and a separator positioned between the sequentially flagged electrode and the second electrode. In some aspects, an energy storage device is described, including an electrode assembly positioned within a housing.

In some aspects, a wound sequentially flagged electrode is described. The wound sequentially flagged electrode includes an electrode film disposed over a foil, where the foil comprises a plurality of flags, and a central core surrounded by the electrode film, where each of the plurality of flags are folded toward the central core, and where the plurality of flags sequentially decrease in height proximal to the central core.

In some embodiments, the central core of the wound sequentially flagged electrode is exposed. In some embodiments, the plurality of flags do not substantially overlap with the central core. In some embodiments, a portion of the plurality of flags are welded together. In some embodiments, the wound sequentially flagged electrode includes a lid connected to the plurality of flags.

In some aspects, a method of preparing a sequentially flagged electrode is described. The method includes providing an electrode comprising an electrode film disposed over a foil, where the foil comprises an exposed foil, and forming a plurality of flags from the exposed foil to form a flagged electrode, where the plurality of flags sequentially decrease in height.

In some embodiments, the method further includes winding the flagged electrode to form a wound flagged electrode comprising a series of wound flags, wherein the plurality of flags sequentially decrease in height towards a central core of the wound flagged electrode. In some embodiments, winding includes folding the plurality of flags to form folded rolled flags. In some embodiments, the folded rolled flags cover a separator in the central core. In some embodiments, the method includes joining the folded rolled flags to form connected flags. In some embodiments, the method includes attaching a lid onto the connected flags.

In some aspects, a method of preparing a tabless energy storage device is described. The method includes providing an electrode roll comprising a plurality of folded rolled flags, joining the plurality of folded rolled flags to form connected flags, and attaching a lid onto the connected flags.

In some embodiments, the plurality of folded rolled flags sequentially decrease in height proximal to a central core. In some embodiments, attaching the lid onto the connected flags includes spot welding the lid onto the connected flags. In some embodiments, attaching the lid onto the connected flags includes spot welding at least 1.8% of a surface area of the lid onto the connected flags. In some embodiments, electrically connecting the plurality of folded rolled flags includes welding the plurality of folded rolled flags to form connected flags.

### BRIEF DESCRIPTION OF THE DRAWINGS

The present inventions are described with reference to the accompanying drawings, in which like reference characters reference like elements, and wherein:

FIG. 1 is a schematic illustration of a flagged electrode.

FIG. 2 is a schematic illustration of a wound flagged electrode.

FIG. 3 is a schematic illustration of a welding arrangement for a lid positioned over a flagged electrode.

FIG. 4 is a schematic illustration of a sequentially flagged electrode, according to some embodiments.

FIG. 5 is a schematic illustration of a wound sequentially flagged electrode, according to some embodiments.

FIG. 6A is schematic illustration of a welding arrangement for a lid positioned over a sequentially flagged electrode, according to some embodiments.

FIG. 6B is schematic illustration of another welding arrangement for a lid positioned over a sequentially flagged electrode, according to some embodiments.

FIG. 7 is a photographic image of a cathode side of a wound electrode assembly, according to some embodiments.

FIG. 8 is a photographic image of a cathode lid positioned over a cathode side of a wound electrode assembly, according to some embodiments.

FIG. 9 is a photographic image of an anode side of a wound electrode assembly, according to some embodiments.

FIG. 10 is a photographic image illustrating an anode side electrode including an anode lid positioned over an electrode roll, according to some embodiments.

FIG. 11A illustrates a flag welding pattern, according to some embodiments.

FIG. 11B illustrates another flag welding pattern, according to some embodiments.

FIG. 12 illustrates a cathode lid weld pattern, according to some embodiments.

FIG. 13 illustrates an anode lid weld pattern, according to some embodiments.

FIG. 14 illustrates a method of preparing a sequentially flagged electrode, according to some embodiments.

FIG. 15 illustrates a method of preparing a tabless energy storage device, according to some embodiments.

FIG. 16A is an experimental chart showing changes in direct contact resistance for different electrodes, according to some embodiments.

FIG. 16B is an experimental chart showing changes in direct contact resistance for different electrodes, according to some embodiments.

FIG. 17A is an experimental chart showing a cell resistance values for electrodes, according to some embodiments.

FIG. 17B is an experimental chart showing a cell resistance values for electrodes, according to some embodiments.

### DETAILED DESCRIPTION

The present disclosure relates to energy storage device cells and methods of making cells for energy storage devices, such as a lithium ion battery having a tabless connection from an electrode to the housing. In one example, within a wound flagged electrode cell design, the negative electrode and/or the positive electrode are formed from electrode foils and are made to include flag structures at their edges for making an electrical connection to the battery can. When each flagged electrode is wound within a wound flagged electrode configuration, the flags may be pressed inward forming an interleaved “flower” or “artichoke” shaped configuration at each end of the wound flagged electrode. In the interleaved configuration, all or substantially all of the flags are successively pressed inward toward the center of the wound flagged electrode configuration where each flag is pressed on top of the flag positioned successively inward. The folded flags may be joined (e.g. form a permanent or semi-permanent connection between the flags by pressing, soldering, laser welding, adhering etc.) to each other and then joined (e.g. form a permanent or semi-permanent connection between the flags by pressing, soldering, laser welding, adhering etc.) to the top and bottom lids at the ends of the battery cell to form a cylindrical unit. The cylindrical unit may then be loaded into a battery can for final processing to form a lithium ion battery.

Each electrode may have a plurality (e.g., dozens or hundreds) of flags and the flags can be of any configuration. For example, the flags may be spaced very close together to form a flower shape when wound within the wound flagged electrode. In other embodiments, the flags may be spaced so that each flag aligns with other flags to form a single line of flags on one side of the wound flagged electrode. In one embodiment, the flags are spaced so that they become interleaved as the wound flagged electrode is formed. In one embodiment, the interleaved flags are able to be compressed to a flat, or substantially flat configuration at each end of the cell. In some embodiments, the flags are spaced so that there are gaps between consecutive flags prior to and/or as the wound electrode assembly (e.g., jelly roll) is formed.

In some embodiments, the flags are each the same height as each other. In some embodiments, the flags sequentially decrease in height. In some embodiments, the flags sequentially decrease in height near the center of the wound flagged electrode. The sequentially decreasing flags can include sequences of flags (e.g., groups of flags) where each sequence of flags has the same or substantially the same flag height.

In some embodiments, the folded flags are joined to each other prior to joining the lid to the folded flags. In some embodiments, the folded flags are welded to each other by radially extending welds. In some embodiments, the lid is joined to the folded flags by spot welds positioned across the lid surface. In some embodiments, the folded flags are welded to each other and then the lid is welded to the folded flags.

In some embodiments, each end of the wound electrode assembly (e.g., cell) is capped with a lid. The lid may be a solid circular metallic structure. In other embodiments, the lid may have cut-outs formed which act to release axial or torsional stress from the components within the wound flagged electrode. For example, a set of triangular, circular, square, rectangular, or other geometric forms can be cut out from the lids to give the lid more ability to bend with stresses placed on the battery cells.

In some embodiments, once a wound flagged electrode is formed it may be used to form an energy storage device, such as a battery. In some embodiments, the folded flags of the wound flagged electrode are electrically connected (e.g., joined) to a lid (e.g., a current collector). In some embodiments, the flags may be connected to the lids by press contact, solder joint, welding, and combinations thereof. In some embodiments, welding is performed by laser welding. In some embodiments, the wound electrode assembly is placed into a can (e.g., housing) and the housing is sealed. In some embodiments, electrolyte is added to the can.

In some embodiments, an energy storage device includes a separator, an anode electrode (e.g., anode wound flagged electrode), a cathode electrode (e.g., a cathode wound flagged electrode), an electrolyte, and a can, wherein the electrolyte, separator, anode electrode and cathode electrode are disposed within the housing and the separator is positioned between the anode and cathode electrodes. In some embodiments, an energy storage device is formed by placing an electrolyte, a separator, an anode electrode, and the cathode electrode within a housing, wherein the separator is placed between the anode electrode and the cathode electrode. In some embodiments the energy storage device is a battery. In some embodiments the energy storage device is a lithium-ion battery. In some embodiments, the energy storage device includes an anode electrode positioned between two cathode electrodes.

Reference will now be made in detail to specific aspects or features, examples of which are illustrated in the accompanying drawings. Wherever possible, corresponding or similar reference numbers will be used throughout the drawings to refer to the same or corresponding parts.

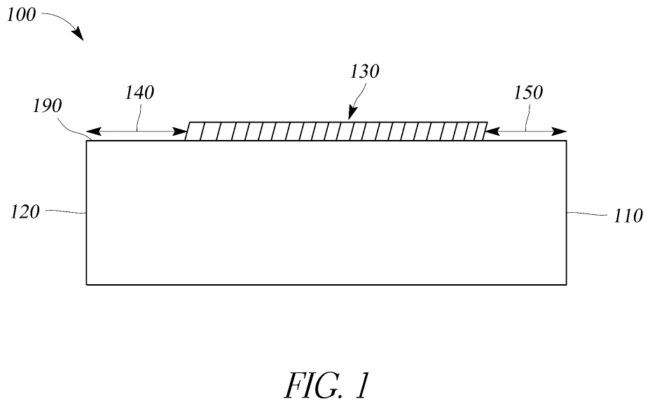

FIG. 1 is a diagram illustrating an unrolled electrode film 100. The unrolled electrode film 100 includes a core edge 120, a can edge 110, and a plurality of flags 130, in some embodiments. A nubless region (i.e., core flagless region) 140 is positioned between the core edge 120 and the plurality of flags 130. A buried region (i.e., can flagless region) 150 is positioned between the can edge 110 and the plurality of flags 130. As illustrated, the plurality of flags 130 are a uniform height. The plurality of flags 130 are positioned along a top edge 190 between the can edge 110 and the core edge 120. The top edge 190 is an edge connecting the can edge 110 to the core edge 120. As illustrated, the unrolled electrode film 100 is substantially rectangular.

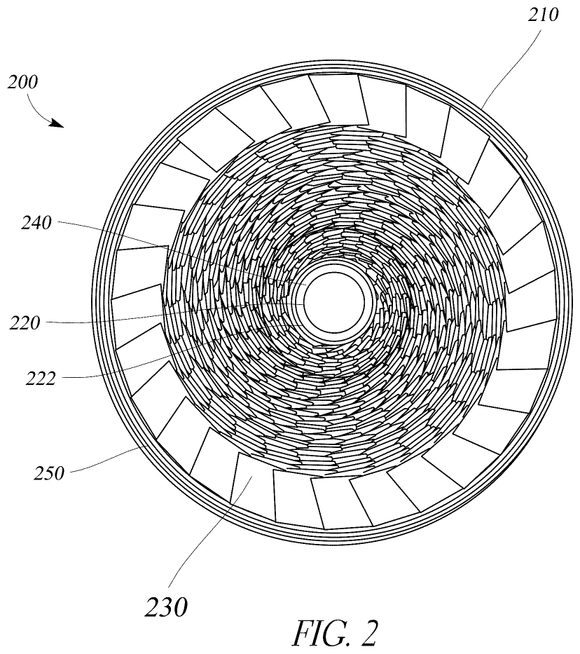

FIG. 2 is a diagram illustrating a wound flagged electrode 200. The wound flagged electrode 200 can be formed from the unrolled electrode film 100 described with reference to FIG. 1. To form the wound flagged electrode 200, the unrolled electrode film 100 is rolled on itself from the core edge 120 to the can edge 110, leaving the top edge 190 with the plurality of flags 130 at the top of the wound flagged electrode 200, the core edge 120 near the center of the wound flagged electrode 200 and the can edge 110 at the exterior of the wound flagged electrode 200. The flagged electrode 200 includes a can 210, a core 220, a separator 222 positioned adjacent to the core 220, and a plurality of flags 230 folded towards the can 210, in some embodiments. The plurality of flags 230 are uniform in height. The plurality of flags 230 has a nubless region 240 which leaves a portion of the separator 222 uncovered by the plurality of flags 230 and the plurality of flags 230 has a buried region 150 which contributes to the plurality of flags 230 not extending all the way out to the can 210.

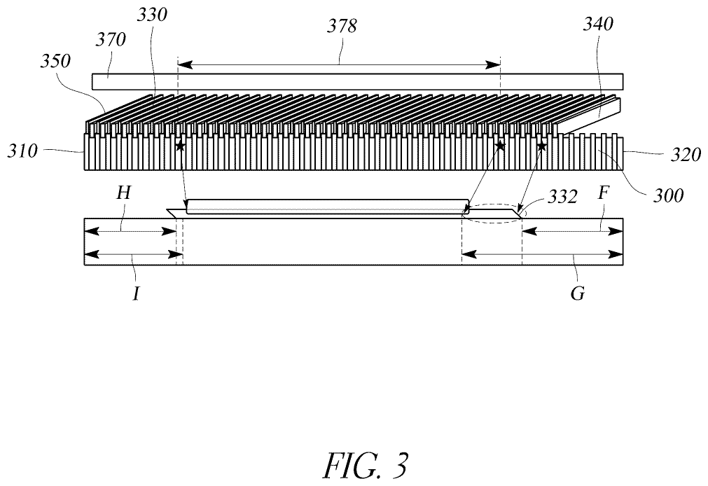

FIG. 3 is a diagram illustrating a welding arrangement for a lid positioned over a plurality of flags of a wound flagged electrode. As illustrated, the figure includes two portions: an upper portion showing a lid 370 positioned over a plurality of flags 330 on an electrode 300; and a lower portion illustrating the plurality of flags 330 and how the welding arrangement joins a portion of the plurality of flags 330. The lid 370 also extends over a nubless region 340 and a buried region 350 of the electrode 300. The electrode 300 includes a can edge 310 and a core edge 320. The nubless region 340 has a length F terminating at the core edge 320. The buried region has a length H. The welding arrangement shows weld 378 which electrically connects a portion of the lid 370 to a portion of the plurality of flags 330. The weld 378 terminates prior to the nubless region 340 leaving a series of core buffer flags 332 unwelded to each other or the lid 370. The weld 378 terminates a distance G from the core edge 320. The weld 378 also terminates prior to the buried region 350 leaving a series of can buffer flags 334. The weld 378 terminates a distance I from the can edge 310.

In some embodiments, the nubless region and buried region are cumulatively approximately 30 percent of the length of the wound flagged electrode (e.g., 30 percent of the surface of the wound flagged electrode is without flags). In some embodiments, approximately 40 percent of the length of the wound flagged electrode is unwelded (e.g., the flags are not joined to the lid over 40 percent of the length).

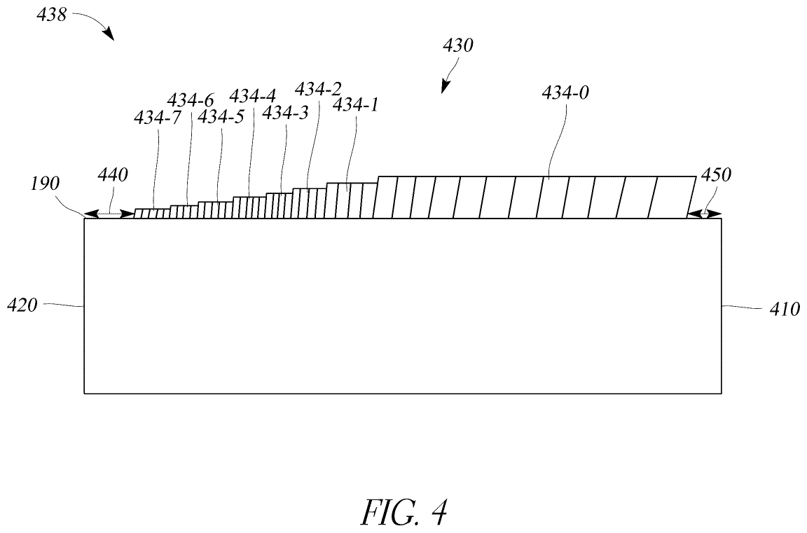

FIG. 4 is a diagram illustrating an unrolled electrode film 400. The unrolled electrode film 400 includes a core edge 420, a can edge 410, and a plurality of flags 430, in some embodiments. A nubless region 440 is positioned between the core edge 420 and the plurality of flags 430. A buried region 450 is positioned between the can edge 410 and the plurality of flags 430. The plurality of flags 430 are positioned along a top edge 490 between the can edge 410 and the core edge 420. As illustrated, the plurality of flags 430 are integral to the unrolled electrode film 400. The plurality of flags 430 includes sequences of flags 434-0 through 434-7 (e.g., groups of flags). The height of each sequence of flags is less than the previous and adjacent sequence of flags. Each flag within a sequence of flags 434-0 through 434-7 is illustrated as having a uniform flag height. The height of the sequence of flags 434-0 closest to the can edge 410 is tallest and extends the majority of the length from the can edge 410 to the core edge 420. Each next sequence of flags is shorter than the previous with the shortest flags 434-7 nearest to the core edge 420. Each of the groups of flags 434-1 through 434-7 extend approximately the same length across the top edge 490, while the sequence of flags closest to the can edge 410 extends a longer length across the top edge 490.

In some embodiments, the nubless region can have a length of between 50 mm and 200 mm. In some embodiments, the nubless region can have a length of, of about, of at least, or at least about, 50 mm, 55 mm, 60 mm, 65 mm, 70 mm, 75 mm, 80 mm, 85 mm, 90 mm, 95 mm, 100 mm, 105 mm, 110 mm, 115 mm, 120 mm, 125 mm, 130 mm, 135 mm, 140 mm, 145 mm, 150 mm, 155 mm, 160 mm, 165 mm, 170 mm, 175 mm, 180 mm, 185 mm, 190 mm, 195 mm, or 200 mm, or any range of values therebetween. In some embodiments, the buried region can have a length of between 5 mm and 50 mm. In some embodiments, the buried region can have a length of, of about, of at least, or at least about, 5 mm, 10 mm, 15 mm, 20 mm, 25 mm, 30 mm, 35 mm, 40 mm, 45 mm, and 50 mm, or any range of values therebetween.

In some embodiments, a sequence of flags can have a height of, of about, of at least, or of at least about, 1 mm, 2 mm, 2.5 mm, 3.5 mm, 4 mm, 4.5 mm, 5 mm, 5.5 mm, 6 mm, 6.5 mm, 7 mm, 8 mm, 9 mm, 10 mm, or 15 mm, or any range of values therebetween. In some embodiments, the tallest sequence of flags has a height of between 3.5 and 7 mm. In some embodiments, the tallest sequence of flags can have a height of, of about, of at least, or at least about, 3.5 mm, 4 mm, 4.5 mm, 5 mm, 5.5 mm, 6 mm, 6.5 mm, or 7 mm, or any range of values therebetween. In some embodiments, each next sequence of flags has a height between 0.1 mm and 0.5 mm shorter than the previous sequence of flags. In some embodiments, the shortest sequence of flags has a height between 2 mm and 5 mm. In some embodiments, the shortest sequence of flags can have a height of, of about, of at least, or at least about, 2 mm, 2.5 mm, 3 mm, 3.5 mm, 4 mm, 4.5 mm, or 5 mm, or any range of values therebetween.

In some embodiments, the plurality of flags includes two sequences of flags, one sequence taller than the other. In some embodiments, the plurality of flags includes 2, 3, 4, 5, 6, 7, 8, 9, 10 or more sequences of flags, or any range of values therebetween. In some embodiments, each sequence of flags includes five flags of the same height. In some embodiments, each sequence of flags includes a different quantity of flags. In some embodiments, each sequence of flags can include 1, 2, 3, 4, 5, 6, 7, 8, 9, 10, 12, 15 or more flags, or any range of values therebetween. In some embodiments, the tallest sequence of flags can include more flags than the other sequences of flags combined.

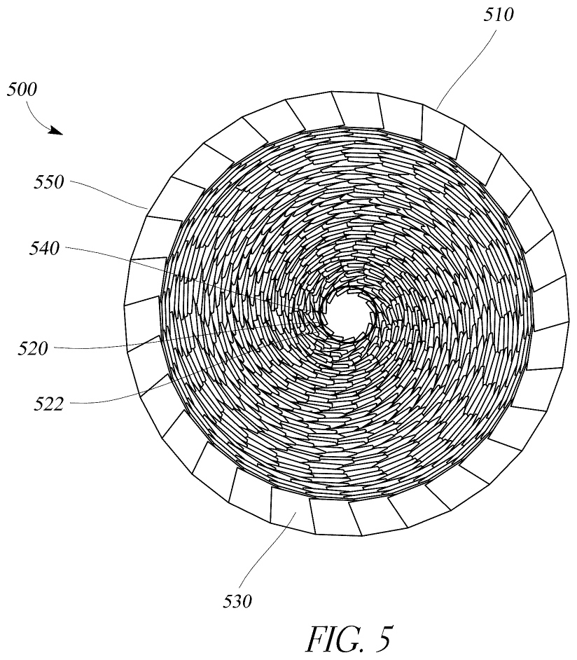

FIG. 5 is a diagram illustrating a wound flagged electrode 500. The wound flagged electrode 500 can be formed from the unrolled electrode film 400 described with reference to FIG. 4. To form the wound flagged electrode 500, the unrolled electrode film 400 is rolled on itself from the core edge 420 to the can edge 410, leaving the top edge 490 with the plurality of flags 430 at the top of the wound flagged electrode 500, the core edge 420 near the center of the wound flagged electrode 500, and the can edge 410 on the perimeter of the wound flagged electrode 500. The flagged electrode 500 includes a can 510, a core 520, a separator 522 positioned adjacent to the core 520, and a plurality of flags 530 folded towards the can 510, in some embodiments. The plurality of flags 530 sequentially decrease in height proximal to the core 520. The plurality of flags 530 cover all or substantially all of the separator 522 and the plurality of flags 530 begin at or substantially at the can 510. The flagged electrode 500 includes a nubless region 540 which is covered or substantially covered by the plurality of flags 530. The flagged electrode 500 may include a buried region 550 adjacent to the can 510.

In some embodiments, once the flagged electrode is wound, the length of the nubless region is approximately the same length as the height of the flags closest to the core, causing all or substantially all of the separator at the core to be covered by the flags. In some embodiments, once the flagged electrode is wound, the length of the nubless region is longer as the height of the flags closest to the core, causing some or all of the separator at the core to be uncovered by the flags. In some embodiments, once the flagged electrode is wound, the length of the buried region is short enough that the flags closest to the can extend to, or approximately to the can. In some embodiments, once the flagged electrode is wound, the length of the buried region is long enough that the flags closest to the can do not extend to the can.

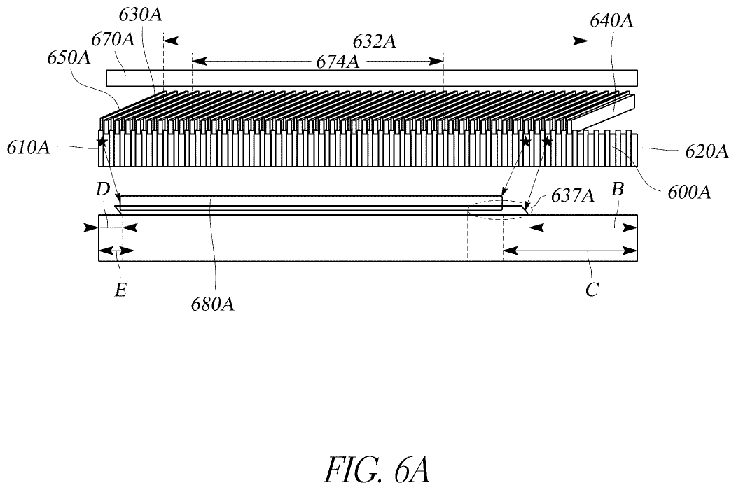

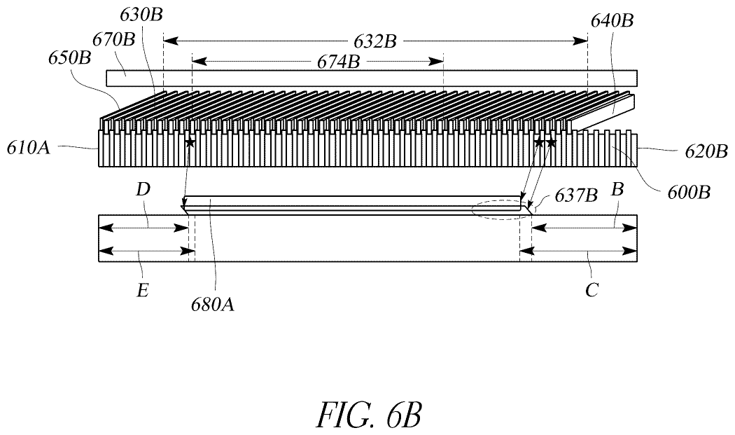

FIG. 6A is a diagram illustrating a welding arrangement for a lid positioned over a plurality of flags of an electrode film. As illustrated, the figure includes two portions: an upper portion showing a lid 370A positioned over a plurality of flags 330A on an electrode 300A; and a lower portion illustrating the plurality of flags 330A and how the welding arrangement joins a portion of the plurality of flags 330A. The lid 670A extends over a nubless region 640A and a buried region 650A of the electrode film 600A. The electrode film 600A includes a can edge 610A and a core edge 620A. The nubless region 640A has a length B terminating at the core edge 620A. The buried region 650A has a length D. The welding arrangement shows a flag weld 632A which electrically connects the majority of the plurality of flags 630A to each other and extends from the buried region 650A to near the nubless region 640A. The flag weld 632A terminates prior to the nubless region 640A leaving a series of buffer flags 637A unwelded to each other or the lid 670A. The welding arrangement shows a lid-flag weld 674A which electrically connects the lid 670A to the plurality of flags 630A. This welding arrangement results in an electrically connected portion 680A. The electrically connected portion 680A illustrates the portion of the electrode film 600A which is in electrical contact with the lid 670A. The electrically connected portion 680A extends the length of the flag weld 632A. This electrically connected portion 680A creates a first contact distance (FCD) from the can edge 610A with length E and a FCD from the core edge 620A with a length C. In some embodiments, the length E is longer, shorter or the same or substantially the same length as length D.

FIG. 6B is a diagram illustrating a welding arrangement for a lid positioned over a plurality of flags of an electrode film. As illustrated, the figure includes two portions: an upper portion showing a lid 370B positioned over a plurality of flags 330B on an electrode 300B; and a lower portion illustrating the plurality of flags 330B and how the welding arrangement joins a portion of the plurality of flags 330B. The lid 670B extends over a nubless region 640B and a buried region 650B of the electrode film 600B. The electrode film 600B includes a can edge 610B and a core edge 620B. The nubless region 640B has a length B terminating at the core edge 620B. The buried region 650B has a length D. The welding arrangement shows a flag weld 632B which electrically connects the majority of the plurality of flags 630B to each other and extends from the buried region 650B to near the nubless region 640B. The flag weld 632B terminates prior to the nubless region 640B leaving a series of buffer flags 637B unwelded to each other or the lid 670B. The welding arrangement shows a lid-flag weld 674B which electrically connects the lid 670B to the plurality of flags 630B. This welding arrangement results in an electrically connected portion 680B. The electrically connected portion 680B illustrates the portion of the electrode film 600B which is in electrical contact with the lid 670B. The electrically connected portion 680B extends the length of the flag weld 632B. This electrically connected portion 680B creates a first contact distance (FCD) from the can edge 610B with length E and a FCD from the core edge 620B with a length C.

FIG. 6B differs from FIG. 6A in that the length D of the buried region 650 is substantially longer in FIG. 6B than in FIG. 6A. Additionally, the length E of the FCD from the can 610 is also substantially longer in FIG. 6B than in FIG. 6A. FIG. 3 differs from FIG. 6A in that the length H of the buried region 350 of FIG. 3 is substantially longer than the length D of the buried region 650A of FIG. 6A. The length F of the nubless region 340 of FIG. 3 is substantially longer than the length B of the nubless region 640A of FIG. 6A. Additionally, the length I of the FCD from the core edge 320 is substantially longer in FIG. 3 than the length E of the FCD from the core edge 620A in FIG. 6A and the length G of the FCD from the can edge 310 is substantially longer in FIG. 3 than the length C of the FCD from the can edge 610A in FIG. 6A.

In some embodiments, the nubless region and/or buried region are, are about, are at most, or are at most about, 1%, 2%, 3%, 4%, 5%, 6%, 7%, 8%, 9%, or 10% of the length of the wound flagged electrode, or any range of values therebetween. In some embodiments, the nubless region and buried region are cumulatively approximately less than 5 percent of the length of the wound flagged electrode (e.g., less than 5 percent of the surface of the wound flagged electrode is without flags). In some embodiments, approximately 5 percent of the length of the wound flagged electrode is unwelded (e.g., the flags are not joined to the lid over 5 percent of the length).

Advantageously, in some embodiments, reducing the length of the buried region and nubless region as illustrated in FIGS. 6A and 6B can improve heat dissipation capability and decrease the heating effect from cell resistance, resulting in less heat generation and energy loss. These factors may improve battery life, reduce the time required for charging, and unlock high performance.

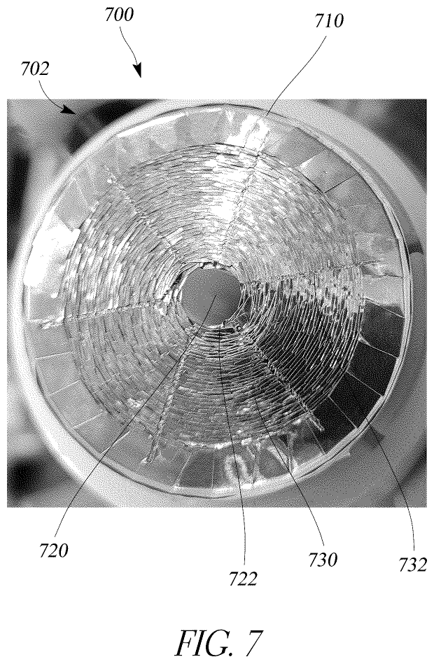

FIG. 7 illustrates a cathode side 702 electrode roll 700. The cathode side 702 electrode roll 700 includes a can 710, a core 720, a separator 722, and a plurality of flags 730. The plurality of flags 730 are connected to each other with a plurality of flag welds 732. As illustrated, the plurality of flag welds 732 includes six radial welds. The plurality of flag welds 732 are distributed at even increments around the electrode roll 700. Each flag weld 732 is approximately 60 degrees apart from the next. As illustrated, each flag weld 732 extends from the flag closest to the can 710 to near the core 720.

In some embodiments, the cathode side electrode roll is formed from aluminum. In some embodiments, the plurality of flag welds can include 2, 3, 4, 5, 6, 7, 8, 9. 10 or more radial welds, or any range of values therebetween. In some embodiments, the flag weld pattern takes a pattern such as a grid pattern, a horizontal or vertical line pattern, a concentric circular pattern, or a spiral pattern. In some embodiments, the plurality of flags can be joined by a method other than welding (e.g., forming a permanent or semi-permanent connection between the flags by pressing, soldering, laser welding, adhering, etc.).

Advantageously, welding the flags to each other prior to welding the flags to the lid allows for more even heat distribution during the welding process and allows welds to extend closer to the can and closer to the core than welding the lid directly to the unconnected flags. Advantageously welds, in some embodiments, that extend closer to the can and closer to the core reduce direct contact resistance (DCR), which may advantageously result in less heat generation and energy loss and thereby improving battery life, and reducing the time required for charging.

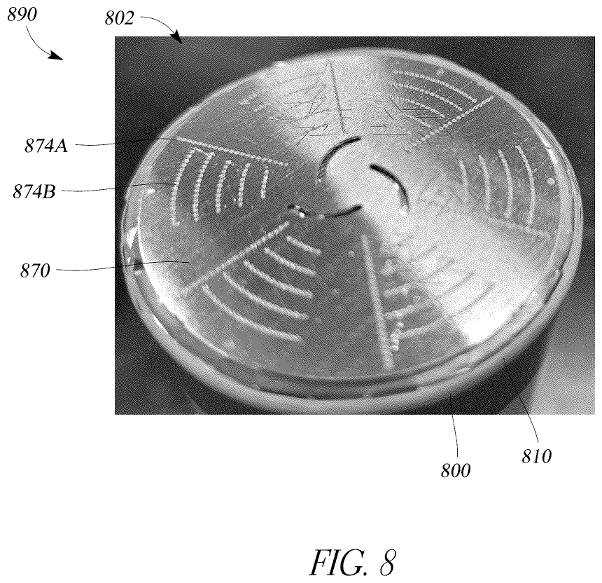

FIG. 8 illustrates a cathode side 802 electrode 890 including a cathode lid 870 positioned over an electrode roll 800. The cathode lid 870 spans over the top of a can 810. The cathode lid 870 is spot welded to the electrode roll 800. The spot weld includes a pattern having radial welds 874A and arcing welds 874B. There are six radial welds 874A spaced evenly around the cathode lid 870. Each radial weld 874A is approximately 60 degrees apart from the next. Adjacent to each radial weld 874A is a series of five arcing welds 874B. Each arcing weld 874B is positioned radial outward from the next.

In some embodiments, the cathode lid is formed from aluminum. In some embodiments the cathode lid is laser welded to the electrode roll. In some embodiments, the cathode lid can be joined to the electrode roll by a method other than welding (e.g., forming a permanent or semi-permanent connection between the flags by pressing, soldering, laser welding, adhering, etc.). In some embodiments, the radial welds include 1, 2, 3, 4, 5, 6, 7, 8, 9, 10, or more radial welds, or any range of values therebetween. In some embodiments, the arcing welds include 0, 1, 2, 3, 4, 5 or more arcing welds, or any range of values therebetween. In some embodiments, the spot weld pattern takes a pattern such as a grid pattern, a horizontal or vertical line pattern, a concentric circular pattern, or a spiral pattern. In some embodiments, the spot weld connects around 1.8% of the surface area of the cathode lid to the electrode roll. In some embodiments, the spot weld connects 1%, 2%, 3%, 4%, 5%, 6%, 7%, 8%, or more, or any range of values therebetween of the surface area of the cathode lid to the electrode roll.

Advantageously, spot welding the flags to the lid allows for less energy being transferred into the flags during the flag-lid welding process and allows spot welds to extend closer to the can and closer to the core.

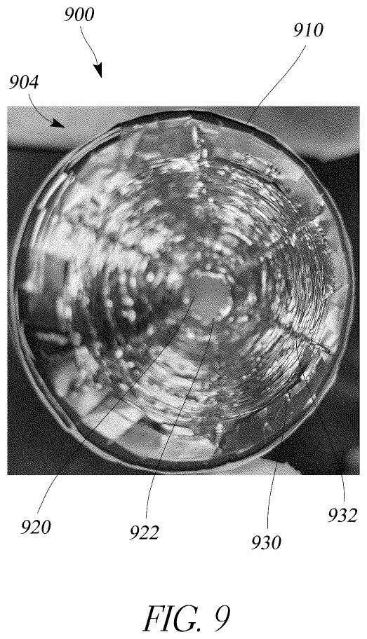

FIG. 9 illustrates an anode side 904 electrode roll 900. The anode side 904 electrode roll 900 includes a can 910, a core 920, a separator 922, and a plurality of flags 930. The plurality of flags 930 are connected to each other with a plurality of flag welds 932. The plurality of flag welds 932 includes six radially extending welds. As illustrated, the plurality of flag welds 932 are distributed at even increments around the electrode roll 900. Each flag weld 932 is approximately 60 degrees apart from the next. As illustrated, each flag weld 932 extends from the flag closest to the can 910 to near the core 920.

In some embodiments, the anode side electrode roll is formed from copper. In some embodiments, the plurality of flag welds can include 2, 3, 4, 5, 6, 7, 8, 9. 10 or more radial welds, or any range of values therebetween. In some embodiments, the flag weld pattern takes a pattern such as a grid pattern, a horizontal or vertical line pattern, a concentric circular pattern, or a spiral pattern. In some embodiments, the plurality of flags can be joined by a method other than welding (e.g., forming a permanent or semi-permanent connection between the flags by pressing, soldering, laser welding, adhering, etc.).

Advantageously, welding the flags to each other prior to welding the flags to the lid allows for more even heat distribution during the welding process and allows welds to extend closer to the can and closer to the core than welding the lid directly to the unconnected flags. In some embodiments, the spot weld connects around 6.2% of the surface area of the anode lid to the electrode roll. In some embodiments, the spot weld connects 1%, 2%, 3%, 4%, 5%, 6%, 7%, 8%, or more, or any range of values therebetween of the surface area of the anode lid to the electrode roll.

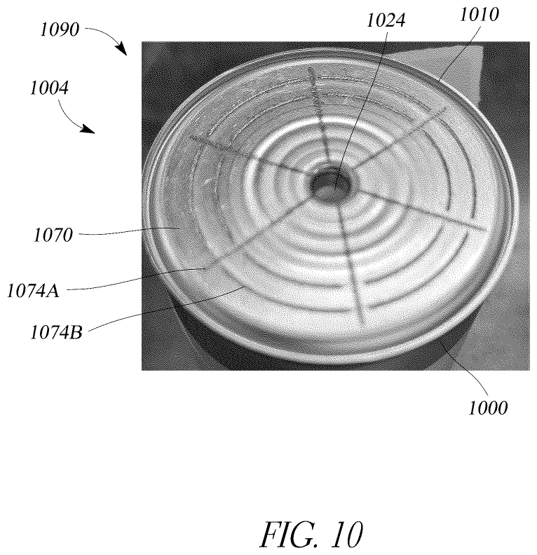

FIG. 10 shows an anode side 1004 electrode 1090 including an anode lid 1070 positioned over an electrode roll 1000. The anode lid includes a central opening 1024. The anode lid 1070 spans over the top of a can 1010. The anode lid 1070 is spot welded to the electrode roll 1000. The spot weld includes a pattern having radial welds 1074A and arcing welds 1074B. There are six radial welds 1074A spaced evenly around the anode lid 1070 and extend from the central opening 1024 towards the can 1010. Each radial weld 1074A is approximately 60 degrees apart from the next. Between every two radial welds 1074A are two arcing welds 1074B. Each arcing weld 1074B is positioned radial outward from the next.

In some embodiments, the anode lid is formed from steel. In some embodiments the anode lid is laser welded to the electrode roll. In some embodiments, the anode lid can be joined to the electrode roll by a method other than welding (e.g., forming a permanent or semi-permanent connection between the flags by pressing, soldering, laser welding, adhering, etc.). In some embodiments, the radial welds include 1, 2, 3, 4, 5, 6, 7, 8, 9, 10, or more radial welds, or any range of values therebetween. In some embodiments, the arcing welds include 0, 1, 2, 3, 4, 5 or more arcing welds, or any range of values therebetween. In some embodiments, the spot weld pattern takes a pattern such as a grid pattern, a horizontal or vertical line pattern, a concentric circular pattern, or a spiral pattern.

Advantageously, spot welding the flags to the lid may allow for less energy being transferred into the flags during the flag-lid welding process and allows spot welds to extend closer to the can and closer to the core.

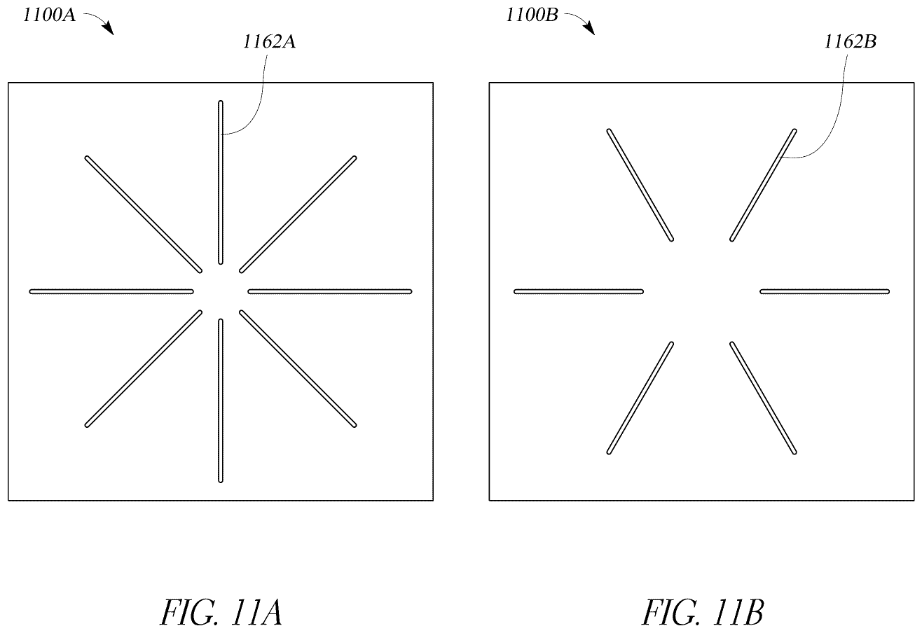

FIG. 11A illustrates a flag welding pattern 1100A. The flag welding pattern 1100A includes a plurality of radial welds 1162A. The plurality of radial welds 1162A include eight radial welds. The plurality of radial welds 1162A can electrically connect the flags of an electrode film. The plurality of radial welds 1162A are evenly spaced and extend radially outward. Each radial weld 1162A is spaced approximately 45 degrees apart from the next.

FIG. 11B illustrates a flag welding pattern 1100B. The flag welding pattern 1100B includes a plurality of radial welds 1162B. The plurality of radial welds 1162B can electrically connect the flags of an electrode film. The plurality of radial welds 1162B includes six radial welds 1162B are evenly spaced and extend radially outward. Each radial weld 1162B is spaced approximately 60 degrees apart from the next.

In some embodiments, the flag welding pattern can include 2, 3, 4, 5, 6, 7, 8, 9. 10 or more radial welds. In some embodiments, the flag weld pattern takes a pattern such as a grid pattern, a horizontal or vertical line pattern, a concentric circular pattern, or a spiral pattern.

FIG. 12 illustrates a cathode lid weld pattern 1200. The cathode lid weld pattern 1200 includes a plurality of radial welds 1264A and a plurality of arcing welds 1264B. The radial welds 1264A and arcing welds 1264B can electrically connect the cathode side flags of an electrode to a cathode lid. The eight radial welds 1264A are evenly spaced and extend radially outward. Each radial weld 1264A is spaced approximately 45 degrees apart from the next. Between every two radial welds 1264A is a grouping of arcing welds 1264B. The arcing welds 1264B include groupings of five arced welds positioned approximately concentrically from each other. Each grouping of arcing welds 1264B is positioned between two of the radial welds 1264A.

In some embodiments, the cathode lid welding pattern can include 2, 3, 4, 5, 6, 7, 8, 9. 10 or more radial welds. In some embodiments, the cathode lid welding pattern takes a pattern such as a grid pattern, a horizontal or vertical line pattern, a concentric circular pattern, or a spiral pattern.

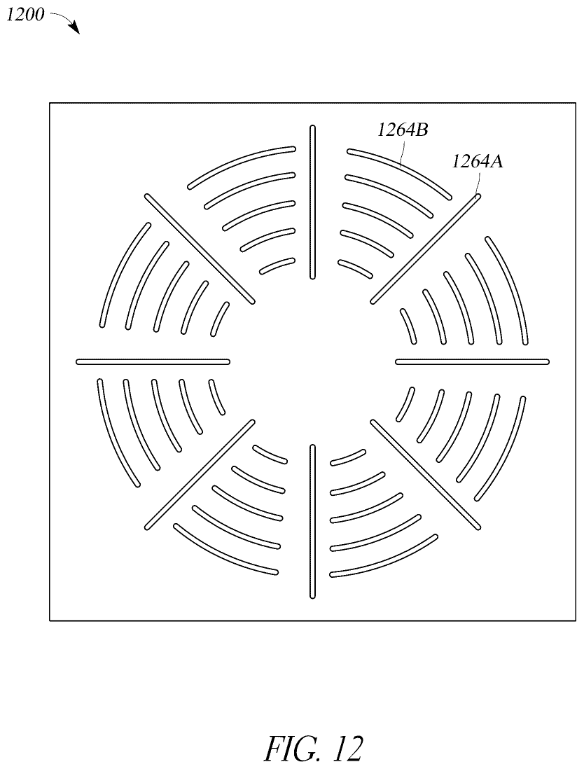

FIG. 13 illustrates an anode lid weld pattern 1300. The anode lid weld pattern 1300 includes a plurality of radial welds 1366A and a plurality of arcing welds 1366B. The radial welds 1366A and arcing welds 1366B can electrically connect the anode side flags of an electrode to an anode lid. The radial welds 1366 include eight radial welds 1366A which are evenly spaced and extend radially outward. Each radial weld 1366A is spaced approximately 45 degrees apart from the next. The arcing welds 1264B include groupings of two arced welds positioned approximately concentrically from each other. Each grouping of arcing welds 1366B is positioned between two of the radial welds 1366A.

In some embodiments, the anode lid welding pattern can include 2, 3, 4, 5, 6, 7, 8, 9. 10 or more radial welds. In some embodiments, the anode lid welding pattern takes a pattern such as a grid pattern, a horizontal or vertical line pattern, a concentric circular pattern, or a spiral pattern.

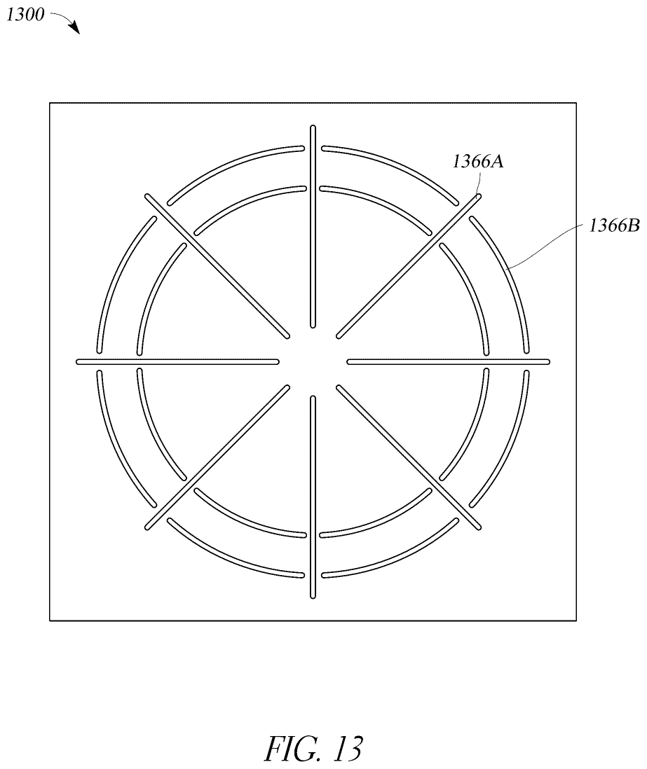

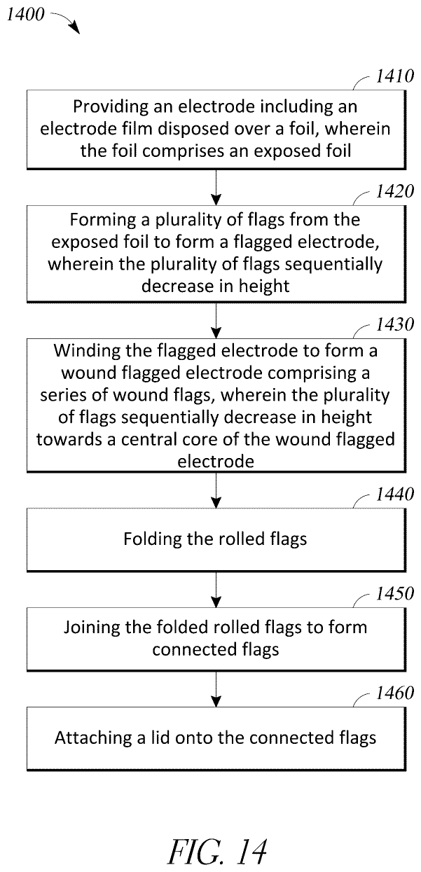

FIG. 14 illustrates a method 1400 of preparing a sequentially flagged electrode. At step 1410, the method includes providing an electrode including an electrode film disposed over a foil, wherein the foil includes an exposed foil. At step 1420, the method includes forming a plurality of flags from the exposed foil to form a flagged electrode, wherein the plurality of flags sequentially decrease in height. At step 1430, the method includes winding the flagged electrode to form a wound flagged electrode comprising a series of wound flags, wherein the plurality of flags sequentially decrease in height towards a central core of the wound flagged electrode. At step 1440, the method includes folding the rolled flags, wherein the folded rolled flags cover a separator in the core. At step 1450, the method includes joining the folded rolled flags to form connected flags. At step 1460, the method includes attaching a lid onto the connected flags.

FIG. 15 illustrates a method 1500 of preparing a tabless energy storage device. At step 1510, the method includes providing an electrode roll including a series of folded rolled flags. At step 1520, the method includes electrically connecting the folded rolled flags to form connected flags. At step 1530, the method includes attaching a lid onto the connected flags.

### Electrode Materials, Electrode Films, Electrodes and Energy Storage Devices

An active material (e.g., cathode active material, anode active material) may be used in the preparation of an electrode film and/or electrode for an energy storage device. In some embodiments, an electrode comprises a current collector and an electrode film.

In some embodiments, the active material is a cathode active material. In some embodiments, the cathode active material is selected from at least one of a metal oxide, metal sulfide, a sulfur-carbon composite, a lithium metal oxide, and a material including sulfur. In some embodiments, the cathode active material is selected from lithium iron phosphate (i.e., LiFePO₄ or “LFP”), lithium manganese iron phosphate (e.g., LiMn_{0.6}Fe_{0.4}PO₄ or “LMFP”), lithium nickel manganese cobalt oxide (i.e., LiNiₓMn_{y}Co_{1-x-y}O₂ or “NMC”), lithium nickel cobalt aluminum oxide (i.e., LiNiₓCo_{y}Al_{z}O₂ or “NCA”), lithium manganese oxide (“LMO”), lithium nickel manganese oxide (“LNMO”), lithium cobalt oxide (“LCO”), lithium titanate (“LTO”), or combinations thereof. In some embodiments, the cathode active material includes at least two of LFP, LMFP, NMC, NCA, LMO, LNMO, LCO, LTO, and combinations thereof. In some embodiments, the cathode active material is an iron phosphate-based active material. In some embodiments, iron phosphate-based active materials include LiFePO₄ (i.e., “lithium iron phosphate” and “LFP”) and LiMn₁₋ₓFeₓPO₄ (i.e., “lithium manganese iron phosphate” and “LMFP”) (e.g., LiMn_{0.6}Fe_{0.4}PO₄ or LiMn_{0.8}Fe_{0.2}PO₄). In some embodiments, the iron phosphate-based active material includes LFP. In some embodiments, the iron phosphate-based active material includes an LMFP. In some embodiments, the iron phosphate-based active material includes an LFP and/or an LMFP.

In some embodiments, the active material is an anode active material. In some embodiments, anode active materials can include, for example, an insertion material (such as carbon, graphite, and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx—C, SnOx—C, Si—Sn, Si—SiOx, Sn—SnOx, Si—SiOx—C, Sn—SnOx—C, Si—Sn—C, SiOx—SnOx—C, Si—SiOx—Sn, or Sn—SiOx—SnOx.). Anode active materials include common natural graphite, synthetic or artificial graphite, surface modified graphite, spherical-shaped graphite, flake-shaped graphite and blends or combinations of these types of graphite, metallic elements and its compound as well as metal-C composite for anode.

In some embodiments, the electrode film comprises the active material in an amount of, of about, of at least, or at least about, 70 wt. %, 75 wt. %, 80 wt. %, 85 wt. %, 86 wt. %, 87 wt. %, 88 wt. %, 89 wt. %, 90 wt. %, 91 wt. %, 92 wt. %, 93 wt. %, 94 wt. %, 95 wt. %, 96 wt. %, 97 wt. %, 98 wt. %, 98.5 wt. %, 99 wt. %, 99.5 wt. %, 99.8 wt. % or 99.9 wt. %, or any range of values therebetween.

In some embodiments, an electrode film comprises a carbon material configured to reversibly intercalate lithium ions. In some embodiments, the lithium intercalating carbon is selected from a graphitic carbon, graphite, hard carbon, soft carbon and combinations thereof. For example, the electrode film of the electrode can include a binder material, one or more of graphitic carbon, graphite, graphene-containing carbon, hard carbon and soft carbon, and an electrical conductivity promoting material. In some embodiments, an electrode is mixed with lithium metal and/or lithium ions. In some embodiments, the electrode comprises the carbon material in a total amount of, of about, of at most, or at most about, 20 wt. %, 15 wt. %, 10 wt. %, 9 wt. %, 8 wt. %, 7 wt. %, 6 wt. %, 5 wt. %, 4 wt. %, 3 wt. %, 2 wt. %, 1 wt. %, or any range of values therebetween.

In some embodiments, an electrode film includes a conductive additive. In some embodiments, the conductive additive may comprise a conductive carbon additive, such as a carbon black. In some embodiments, the conductive additive may comprise a conductive carbon additive. In some embodiments, the conductive carbon additive comprises carbon black, carbon nanotubes, such as single-walled carbon nanotubes (SWCNTs) and multi-walled carbon nanotubes (MWCNTs). In some embodiments, the electrode film comprises the conductive additive in a total amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, or any range of values therebetween. In some embodiments, each of the conductive additive is in an amount of, of about, of at most, or at most about, 10 wt. %, 9 wt. %, 8 wt. %, 7 wt. %, 6 wt. %, 5 wt. %, 4 wt. %, 3 wt. %, 2 wt. %, 1 wt. %, 0.5 wt. %, 0.25 wt. %, 0.1 wt. %, of the electrode film, or any range of values therebetween. In some embodiments, the conductive additive is carbon black.

In some embodiments, the electrode film includes a binder. In some embodiments, binders can include polytetrafluoroethylene (PTFE), a polyolefin, polyalkylenes, polyethers, styrene-butadiene, co-polymers of polysiloxanes and polysiloxane, branched polyethers, polyvinylethers, a carboxymethylcellulose (CMC), co-polymers thereof, and/or combinations thereof. In some embodiments, the polyolefin can include polyethylene (PE), polypropylene (PP), polyvinylidene fluoride (PVDF), co-polymers thereof, and/or combinations thereof. For example, the binder can include polyvinylene chloride, poly(phenylene oxide) (PPO), polyethylene-block-poly(ethylene glycol), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, co-polymers thereof, and/or combinations thereof. In some embodiments, the binder may include a thermoplastic. In some embodiments, the binder comprises a fibrillizable and/or fibrillized polymer. In certain embodiments, the binder comprises, consists essentially, or consists of a single fibrillizable and/or fibrillized binder, such as PTFE. In some embodiments, the electrode film includes, includes about, includes at most, or includes at most about, 1 wt. %, 2 wt. %, 3 wt. %, 4 wt. %, 5 wt. %, 6 wt. %, 7 wt. %, 8 wt. %, 9 wt. %, 10 wt. %, or any range of values therebetween, of a binder.

In some embodiments, the electrode film can be a wet processed electrode film. In some embodiments, the electrode film is prepared by a wet or slurry-based electrode fabrication process. In some embodiments, the electrode film of the present disclosure can be a dry processed electrode film. In some embodiments, the electrode film is prepared by a dry electrode fabrication process. As used herein, a dry electrode fabrication process can refer to a process in which no or substantially no solvents are used to form a dry electrode film. For example, components of the active layer or electrode film, including carbon materials and binders, may comprise, consist of, or consist essentially of dry particles. The dry particles for forming the active layer or electrode film may be combined to provide a dry particle active layer mixture. In some embodiments, the active layer or electrode film may be formed from the dry particle active layer mixture such that weight percentages of the components of the active layer or electrode film and weight percentages of the components of the dry particles active layer mixture are substantially the same. In some embodiments, the active layer or electrode film formed from the dry particle active layer mixture using the dry fabrication process may be free from, or substantially free from, any processing additives such as solvents and solvent residues resulting therefrom. In some embodiments, the resulting active layer or electrode films are self-supporting films formed using the dry process from the dry particle mixture. In some embodiments, the resulting active layer or electrode films are free-standing films formed using the dry process from the dry particle mixture. A process for forming an active layer or electrode film can include fibrillizing the fibrillizable binder component(s) such that the film comprises fibrillized binder. In further embodiments, a free-standing active layer or electrode film may be formed in the absence of a current collector. In still further embodiments, an active layer or electrode film may comprise a fibrillized polymer matrix such that the film is self-supporting. It is thought that a matrix, lattice, or web of fibrils can be formed to provide mechanical structure to the electrode film.

In some embodiments, an electrode film is disposed on a current collector to form an electrode. In some embodiments, a current collector can include a metallic material, such as a material comprising aluminum, nickel, copper, combinations of the foregoing. In some embodiments, a current collector comprises a pure metal. In some embodiments, a current collector comprises a metallized polymer film or metal coated polymer film. In some embodiments, the polymer comprises polyethylene terephthalate (PET), biaxially oriented polypropylene (BOPP) or a combination thereof. In some embodiments, the metal coating comprises aluminum. In some embodiments, coating the final electrode film mixture comprises forming a uniform electrode film mixture coating. In some embodiments, the current collector comprises a thickness of, of about, of at most, or at most about, 200 μm, 100 μm, 50 μm, 40 μm, 30 μm, 20 μm, 15 μm, 10 μm, 5 μm, or any range of values therebetween.

In some embodiments, an electrode is a double-sided electrode. In some embodiments, the double-sided electrode includes two electrode films. In some embodiments, the double-sided electrode may include a current collector, a top electrode film, and a bottom electrode film. In some embodiments, each of the two electrode films can have any suitable shape, size and thickness.

In some embodiments, the energy storage device comprises a separator, an anode electrode, the cathode electrode, an electrolyte, and a housing, wherein the electrolyte, separator, anode electrode and cathode electrode are disposed within the housing and the separator is positioned between the anode and cathode electrodes. In some embodiments, an energy storage device is formed by placing an electrolyte, a separator, an anode electrode and the cathode electrode described herein within a housing, wherein the separator is placed between the anode electrode and the cathode electrode.

An electrode assembly includes a cathode, an anode, and a separator positioned between the anode and cathode. In some embodiments, the electrode assembly is a wound electrode (i.e., rolled electrode) assembly (e.g., a jelly roll). In some embodiments, the energy storage device is selected from the group consisting of a cylindrical energy storage device, a stacked prismatic energy storage device, and a spiral-wound prismatic energy storage device.

The electrode disclosed herein may be used for an energy storage device. In some embodiments, the energy storage device comprises a separator, an anode electrode, the cathode electrode, an electrolyte, and a housing, wherein the electrolyte, separator, anode electrode and cathode electrode are disposed within the housing and the separator is positioned between the anode and cathode electrodes. In some embodiments, an energy storage device is formed by placing an electrolyte, a separator, an anode electrode and the cathode electrode described herein within a housing, wherein the separator is placed between the anode electrode and the cathode electrode. In some embodiments, the energy storage device comprises an anode electrode positioned between two cathode electrodes. In some embodiments, the anode electrode and/or the cathode electrode comprises a shaped electrode film. In some embodiments, the energy storage device is a lithium-ion battery. In some embodiments, the energy storage devices may be a battery, capacitor, capacitor-battery hybrid, fuel cell, or combinations thereof. In some embodiments, the energy storage system or energy storage device may be used for electromobility. In some embodiments, the energy storage device may be used in motor vehicles, including hybrid electric vehicles (HEV), plug-in hybrid electric vehicles (PHEV), and/or electric vehicles (EV). In some embodiments, the energy storage device used in motor vehicles, including hybrid electric vehicles (HEV), plug-in hybrid electric vehicles (PHEV), and/or electric vehicles (EV) reduces greenhouse gas emissions.

In some embodiments, the energy storage device is charged with a suitable lithium-containing electrolyte. For example, the energy storage device can include a lithium salt, and a solvent, such as a non-aqueous or organic solvent. Generally, the lithium salt includes an anion that is redox stable. In some embodiments, the anion can be monovalent. In some embodiments, a lithium salt can be selected from lithium hexafluorophosphate (LiPF₆), lithium bis(trifluoromethanesulfonyl)imide (LiFSI), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), lithium bis(oxalato)borate (LiB(C₂O₄)₂), lithium bis(fluorosulfonyl)imide (LiN(SO₂F)₂, lithium difluoro(oxalato)borate (LiC₂BF₂O₄) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 2 M. In certain embodiments, the salt concentration of the electrolyte can be about 0.2 M, about 0.3 M, about 0.4 M, about 0.5 M, about 0.6 M, about 0.7 M, about 0.8 M. about 0.9 M, about 1 M, about 1.1 M, about 1.2 M, 1.3M, 1.4M, 1.5M or values therebetween.

In some embodiments, an energy storage device can include a liquid solvent. The solvent need not dissolve every component, and need not completely dissolve any component, of the electrolyte. In further embodiments, the solvent can be an organic solvent. In some embodiments, a solvent can include one or more functional groups selected from dioxathiolane (e.g., 1,3,2-dioxathiolane-2,2-dioxide (i.e., “DTD”)), carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), and combinations thereof, or acyclic carbonates such as, for example, dimethyl carbonate (DMC), diethyl carbonate (DEC), ethyl methyl carbonate (EMC), and combinations thereof. In some embodiments, one or more solvents can be used at a concentration of, of about, of at least, or at least about, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. % or 90 wt. %, or any range of values therebetween. In some embodiments, solvents are utilized as additives in the electrolyte system, and can be used at a concentration of, of about, of at most, or at most about, 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3 wt. %, 4 wt. %, 5 wt. %, 6 wt. %, 7 wt. %, 8 wt. %, 9 wt. % or 10 wt. %, or any range of values therebetween. For example, in some embodiments, the amount of an additive in the electrolyte is or is about in any one of the following ranges: 0.1-10 wt. %, 1-6 wt. %, 2-5 wt. %, 0.1-6 wt. %, 2-8 wt. %, 2-3 wt. %, or 1-4 wt. %.

In some embodiments, an energy storage device is created such that one electrode (e.g., anode) is larger than and overhangs the other electrode (e.g., cathode). One electrode may overhang the other in the winding direction and/or non-winding direction of the electrode assembly. Such electrode overhangs may avoid yield losses. In some embodiments where there is no, or is substantially no, overlap and/or intermingling of the separator and the shaped electrode film (e.g., cathode electrode film), the boundary of the shaped electrode film is easier to identify and therefore improves the ability to form a counter electrode (e.g., anode electrode) with an overhang.

### EXAMPLES

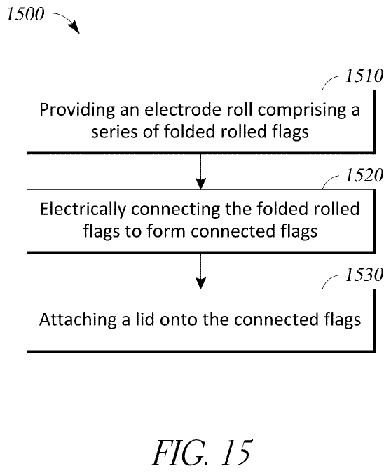

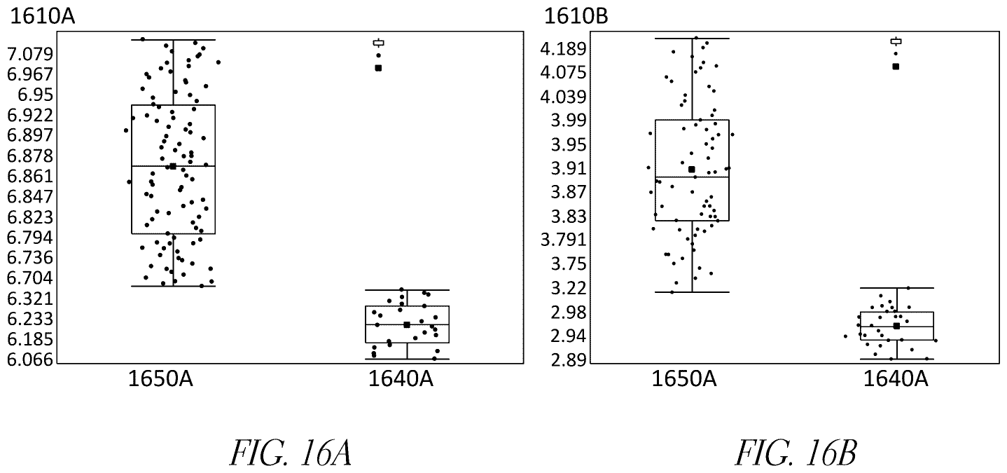

FIG. 16A and FIG. 16B are experimental charts showing the change in direct contact resistance (DCR) for electrodes with flag welding (e.g., the electrode is formed by first welding the flags to each other and then welding the lid to the flags) compared to electrodes with lid to flag welding (e.g., the lid is directly welded to the flags without first welding the flags to each other). FIG. 16A illustrates results under production testing conditions and FIG. 16B illustrates results under performance testing conditions. The production test conditions can include a C2 charge rate at 100% state of charge, 25° C. temperature, and a 10 second discharge pulse. The performance test conditions can include a 4C charge rate at 50% state of charge, 60° C., and a 30 second discharge pulse. As illustrated, in FIG. 16A, the Y-axis illustrates DCR in units of [symbol] . Both the lid to flag welding electrode test results and the flag welding electrode test results are shown to illustrate how the welding arrangement changes DCR. As illustrated, DCR is reduced for the flag welding electrode compared with the lid to flag welding electrode. As illustrated, in FIG. 16B, the Y-axis illustrates DCR in units of [symbol] . The lid to flag welding electrode test results are illustrated and the flag welding electrode test results are illustrated. As illustrated, DCR is reduced for the flag welding electrode compared with the lid to flag welding electrode.

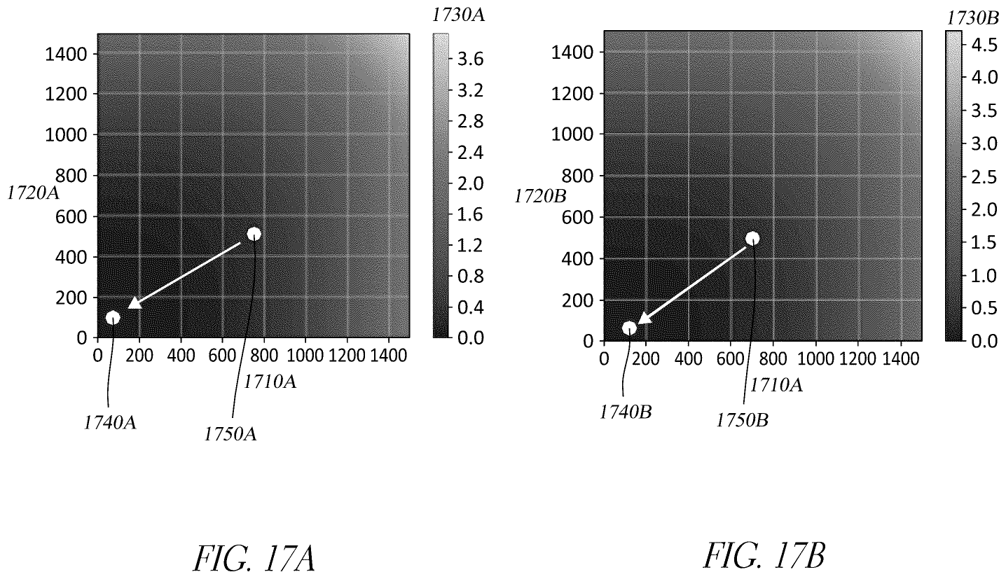

FIG. 17A and FIG. 17B are experimental charts illustrating a cell resistance value for electrode which are identical other than the can side and core side FCD values. FIG. 17A illustrates anode side electrodes. Along the X-axis core side FCD distance is mapped. Along the Y-axis can side FCD distance is mapped. The gradient scale illustrates anode side electrode resistance. Point 1750A illustrates an electrode having a longer core side FCD distance and a longer can side FCD distance. Point 1740A illustrates an electrode having a shorter core side FCD distance and a shorter can side FCD distance. As illustrated, point 1740A has a smaller resistance than point 1750A. FIG. 17B illustrates cathode side electrodes. Along the X-axis core side FCD distance is mapped. Along the Y-axis can side FCD distance is mapped. The gradient scale illustrates cathode side electrode resistance. Point 1750B illustrates an electrode having a longer core side FCD distance and a longer can side FCD distance. Point 1740B illustrates an electrode having a shorter core side FCD distance and a shorter can side FCD distance. As illustrated, point 1740B has a smaller resistance than point 1750B.

The foregoing disclosure is not intended to limit the present disclosure to the precise forms or embodiments disclosed herein. As such, it is contemplated that various alternative forms, embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed battery system. It is to be understood that the forms of disclosure herein shown and described are to be taken as representative embodiments. Equivalent elements, or materials may be substituted for those representatively illustrated and described herein. Moreover, certain features of the disclosure may be utilized independently of the use of other features, all of which is apparent to one skilled in the art after having the benefit of this description of the disclosure. Expressions such as “including”, “comprising”, “incorporating”, “consisting of’, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., connected, associated, coupled, and the like) are only used to aid the reader's understanding of the present disclosure, and may not create limitations, particularly as to the position, orientation, or use of the elements disclosed herein. Therefore, joinder references, if any, are to be construed broadly. Moreover, such joinder references may not necessarily infer that two elements are directly connected to each other.

Additionally, all numerical terms, such as, but not limited to, “first”, “second”, “one”, “another”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed in certain cases, as is useful in accordance with a particular application.

For expository purposes, the term “horizontal” as used herein is defined as a plane parallel to the plane or surface of the floor of the area in which the device being described is used or the method being described is performed, regardless of its orientation. The term “floor” can be interchanged with the term “ground.” The term “vertical” refers to a direction perpendicular to the horizontal as just defined. Terms such as “above,” “below,” “bottom,” “top,” “side,” “front,” “rear,” “lateral,” “higher,” “lower,” “upper,” “over,” and “under,” are defined with respect to the horizontal plane, in use.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Although certain embodiments and examples have been described herein, it will be understood by those skilled in the art that many aspects of the systems shown and described in the present disclosure may be differently combined and/or modified to form still further embodiments or acceptable examples. All such modifications and variations are intended to be included herein within the scope of this disclosure. A wide variety of designs and approaches are possible. No feature, structure, or step disclosed herein is essential or indispensable.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed processes and methods may be modified in any manner, including by reordering actions and/or inserting additional actions and/or deleting actions. It is intended, therefore, that the specification and examples be considered as illustrative only, with a true scope and spirit being indicated by the claims and their full scope of equivalents.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

The ranges disclosed herein also encompass any and all overlap, sub-ranges, and combinations thereof. Language such as “up to,” “at least,” “greater than,” “less than,” “between,” and the like includes the number recited.

What is claimed is:

1. A sequentially flagged electrode, comprising:
an electrode film; and
a foil disposed under the electrode film;
wherein the foil comprises a core edge, a can edge, and a plurality of flags positioned along a top edge, wherein the top edge is between the core and can edges;
wherein the plurality of flags comprise a first flag comprising a first flag height and a second flag comprising a second flag height;
wherein the first flag is positioned between the core edge and the second flag, and the second flag is positioned between the first flag and the can edge; and
wherein the first flag height is less than the second flag height.

2. The sequentially flagged electrode of claim 1, wherein the top edge further comprises a nubless region between the core edge and the plurality of flags.

3. The sequentially flagged electrode of claim 1, wherein the top edge further comprises a buried region between the can edge and the plurality of flags.

4. The sequentially flagged electrode of claim 1, wherein the plurality of flags sequentially decrease in height from the can edge to the core edge.

5. The sequentially flagged electrode of claim 1, wherein:
the sequentially flagged electrode is a wound sequentially flagged electrode;
the plurality of flags are positioned at a top end of the wound sequentially flagged electrode;
the core edge is positioned at a central core of the wound sequentially flagged electrode; and
the can edge is positioned at an exterior side of the wound sequentially flagged electrode.

6. An electrode assembly, comprising:
the sequentially flagged electrode of claim 5;
a second electrode; and
a separator positioned between the sequentially flagged electrode and the second electrode.

7. An energy storage device, comprising the electrode assembly of claim 6 positioned within a housing.

8. A wound sequentially flagged electrode, comprising:
an electrode film disposed over a foil, wherein the foil comprises a plurality of flags; and
a central core surrounded by the electrode film;
wherein each of the plurality of flags are folded toward the central core; and
wherein the plurality of flags sequentially decrease in height proximal to the central core.

9. The wound sequentially flagged electrode of claim 8, wherein a central core is exposed.

10. The wound sequentially flagged electrode of claim 8, wherein the plurality of flags do not substantially overlap with the central core.

11. The wound sequentially flagged electrode of claim 8, wherein a portion of the plurality of flags are welded together.

12. The wound sequentially flagged electrode of claim 11, further comprising a lid connected to the plurality of flags.

13. A method of preparing a sequentially flagged electrode, comprising:
providing an electrode comprising an electrode film disposed over a foil, wherein the foil comprises an exposed foil; and
forming a plurality of flags from the exposed foil to form a flagged electrode, wherein the plurality of flags sequentially decrease in height.

14. The method of claim 13, further comprising winding the flagged electrode to form a wound flagged electrode comprising a series of wound flags, wherein the plurality of flags sequentially decrease in height towards a central core of the wound flagged electrode.

15. The method of claim 14, wherein winding comprises folding the plurality of flags to form folded rolled flags.

16. The method of claim 15, wherein the folded rolled flags cover a separator in the central core.

17. The method of claim 15, further comprising joining the folded rolled flags to form connected flags.

18. The method of claim 17, further comprising attaching a lid onto the connected flags.

19. A method of preparing a tabless energy storage device, comprising:
providing an electrode roll comprising a plurality of folded rolled flags;
joining the plurality of folded rolled flags to form connected flags; and
attaching a lid onto the connected flags.

20. The method of claim 19, wherein the plurality of folded rolled flags sequentially decrease in height proximal to a central core.

21. The method of claim 19, wherein attaching the lid onto the connected flags comprises spot welding the lid onto the connected flags.

22. The method of claim 21, wherein attaching the lid onto the connected flags comprises spot welding at least 1.8% of a surface area of the lid onto the connected flags.

23. The method of claim 19, wherein electrically connecting the plurality of folded rolled flags comprises welding the plurality of folded rolled flags to form connected flags.
